(19) United States
(12) Patent Application Publication
(10) Pub. No.: US 2021/0025154 A1
(43) Pub. Date: Jan. 28, 2021

(54) FLOOD PREVENTION SYSTEM

(71) Applicant: Forrest Lee Gregge, Thousand Oaks, CA (US)

(72) Inventor: Forrest Lee Gregge, Thousand Oaks, CA (US)

(21) Appl. No.: 16/935,185

(22) Filed: Jul. 21, 2020

Related U.S. Application Data
(60) Provisional application No. 62/877,148, filed on Jul. 22, 2019.

(51) Int. Cl. E03F 7/02; E03F 5/04; G05D 7/06; G08B 7/06

(52) U.S. Cl. CPC E03F 7/02; G08B 7/06; G05D 7/0652; E03F 5/0407

(57) ABSTRACT

Provided herein are embodiments of a flood prevention system. The flood prevention system may include a water line, a sewer line, and at least one floating switch sensor. The water line and sewer line may be connected to a plumbing fixture. The floating switch sensor may be installed within the sewer line and be connected to a solenoid valve.

### CROSS-REFERENCE TO RELATED APPLICATIONS

This application claims priority to U.S. Provisional Patent Application No. 62/877,148, filed Jul. 22, 2019, the disclosure of which is hereby incorporated by reference in its entirety.

### FIELD

Embodiments of the present disclosure relate to sewer system maintenance, and more specifically to managing blockages in sewer lines.

### BACKGROUND

In a multistory building, such as a condominium complex, the sewer system consists of three main components—vertical stacks, branch lines, and horizontal underground lines. All of these different types of plumbing pipes work together to ensure the sewer lines drain. Multistory buildings have one main drain line for multiple units. However, these sewer systems may backup from time-to-time. Apartment and condo sewers can backup for a variety of reasons, including grease and food particle clogs, tenants flushing or dumping drain clogging materials down the drains, like paper towels, facial tissues and sanitary items, and root infiltration or pipe collapses. When this drain becomes clogged, it causes flooding in the first story units from water usage in the units above. The damage from this can be severe and cost tens of thousands of dollars to repair, in addition to the inconvenience to the tenant. Construction companies perform water damage restoration for this type of damage very frequently. Furthermore, because this type of flooding is mostly, if not always, sewage water, anything it touches is automatically contaminated and needs to be completely replaced.

Such blockages damage the sewer line and may even result in water damage to the apartment, and thus maintenance is required. In multiple story buildings, one of the main causes for the sewer line damage and/or the water damage is a blockage in the sewer line that causes the first story of the building to flood when any of the units above the first story in the building use water. This is a very common problem in largescale communities that only have one sewer line for multiple units. In some cases, at a time, up to 35 units share one waste line, which can cause severe flooding in the lower units when there is a blockage.

People currently address this issue by servicing the waste line after it has already caused a flood. It can cost upwards of $200,000 per building to upgrade or replace the waste line. And if they do not upgrade or replace the line, the flooding will continue to happen and they will have to pay to repair the damage.

Accordingly, there is a need for devices, methods, and systems that detect when a blockage has occurred in the sewer line and water starts backing up. Such devices, methods, and systems may automatically or manually shut down the water supply when a blockage is detected in the sewer lines. When the water supply is turned off, the devices, methods, and systems described herein may prevent anyone from using toilets, showers, sinks, etc. and the blockage may no longer cause the sewer lines to back up to the point of flooding.

### SUMMARY

Provided herein are embodiments of a flood prevention system. In some embodiments, the flood prevention system may include float switches that run parallel to the waste line and may be activated when the water backs up. This may trigger power gate valves that shut the water off to the units connected to the clogged waste line.

The flood prevention system may include a water line, a sewer line, and at least one floating switch sensor. The water line and sewer line may be connected to a plumbing fixture. The floating switch sensor may be installed within the sewer line and be connected to a solenoid valve.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the disclosure is not limited to the specific embodiments described in the Detailed Description and/or other sections of this document. Such embodiments are presented herein for illustrative purposes only. Additional features and advantages of the disclosure will be set forth in the descriptions that follow, and in part will be apparent from the description, or may be learned by practice of the disclosure. The objectives and other advantages of the disclosure will be realized and attained by the structure particularly pointed out in the written description, claims and the appended drawings.

### BRIEF DESCRIPTION OF THE DRAWINGS

The present disclosure may be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a high-level view of a flood prevention system according to exemplary embodiments of the present disclosure.

FIG. 2 illustrates an exemplary view of a vertical waste line in a flood prevention system according to exemplary embodiments of the present disclosure.

FIG. 3 illustrates a top view of a flood prevention system according to exemplary embodiments of the present disclosure.

FIG. 4 illustrates a float switch of a flood prevention system according to exemplary embodiments of the present disclosure.

FIG. 5 illustrates a normally closed solenoid valve of a flood prevention system according to exemplary embodiments of the present disclosure.

FIGS. 6A and 6B illustrate normally open solenoid valve of a flood prevention system according to exemplary embodiments of the present disclosure.

FIGS. 7A and 7B illustrate a various components of a remote transmitter box of a flood prevention system according to exemplary embodiments of the present disclosure.

FIGS. 8A and 8B illustrate a various components of a remote receiver command center of a flood prevention system according to exemplary embodiments of the present disclosure.

### DETAILED DESCRIPTION

The below described figures illustrate the described disclosure and method of use in at least one of its preferred, best mode embodiments, which is further defined in detail in the following description. Those having ordinary skill in the art may be able to make alterations and modifications to what is described herein without departing from its spirit and scope. While this disclosure is susceptible to different embodiments in different forms, there is shown in the drawings and will herein be described in detail a preferred embodiment of the disclosure with the understanding that the present disclosure is to be considered as an exemplification of the principles of the disclosure and is not intended to limit the broad aspect of the disclosure to the embodiment illustrated. All features, elements, components, functions, and steps described with respect to any embodiment provided herein are intended to be freely combinable and substitutable with those from any other embodiment unless otherwise stated. Therefore, what is illustrated is set forth only for the purposes of example and should not be taken as a limitation on the scope of the present disclosure.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

Before further detailed descriptions are disclosed, some terminology and components as used in the present disclosure may first be described.

Float Switch: A float switch may open or close a circuit as the level of a liquid rises or falls. Most float switches are normally “closed,” meaning the two wires coming from the top of the float switch complete a circuit when the float is at its buoyant high point (for example, when a sewer line is full).

In some embodiments, to complete a circuit, the float switch may utilize a magnetic reed switch, which may include two contacts sealed in a glass tube. When a magnet comes close to the two contacts, they become attracted to each other and touch, allowing current to pass through. When the magnet moves away, the contacts demagnetize and separate, thus breaking the circuit.

In the float switch, the magnetic reed switch may be hermetically sealed in a stem, most often made from plastic or stainless steel. The float switch may encase a sealed magnet, which moves up and down the length of the stem as a fluid level rises and falls. As the magnet passes by the contacts in the encased reed switch, they touch and complete a circuit between the two lead wires. Properly used, float switches can deliver millions of on/off cycles, for years of dependable operation. Failures are normally due to overloading, frequently caused by spiking voltage. In some embodiments, the float switch may be connected to an alarm. The alarm may provide audio/visual warning of potential threatening conditions in the sewer lines.

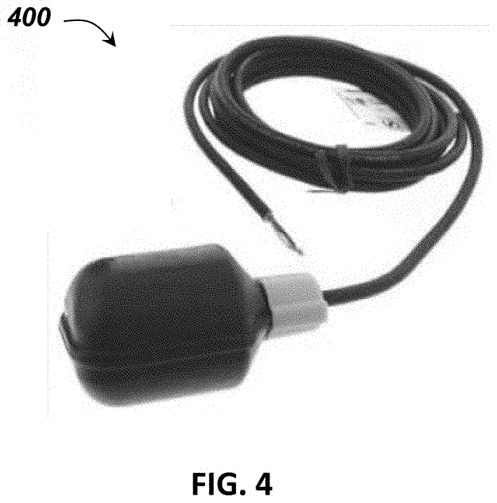

FIG. 4 illustrates an exemplary float switch 400, according to some embodiments.

Relay: The magnetic reeds enclosed in the liquid level sensors are extremely reliable and long-lasting when utilized properly. Failures may be nearly always a result of current overloading. Solenoids and many other devices that require control by a liquid level sensor carry “steady state” current ratings. These devices can draw ten times (or more) their steady state power ratings on start-up or shutdown. When the reeds inside the float switch is exposed to this kind of “spiking voltage” they can overheat and become deformed. In some cases, they may even weld together or break off, causing the switch circuit to remain closed (or open) regardless of the level of the float. Deformed reeds can also function intermittently, causing problems with troubleshooting. A 50-watt float switch can be destroyed by a solenoid valve rated at 6 watts and, unfortunately, it may take many cycles before the failure occurs. Because they can destroy an otherwise very reliable float switch, care needs to be taken to completely isolate the switch from the current drawn by solenoids or other devices subject to spiking voltage. Resistors or diodes may be used, but the most common solution is to utilize a circuit board or a relay. A relay may act as a switch for a solenoid, thereby isolating the float switch from any spikes that the solenoid valve may draw. The float switch turns the relay coil on and off. In this way, the only current handled by the float switch is that small amount required by the relay coil.

Timer Relay: A timer relay is a combination of an electromechanical output relay and a control circuit. The contacts will open or close before or after a pre-selected, timed interval.

Power Solenoid Valve: A solenoid valve is an electromechanical device used for controlling liquid or gas flow. The solenoid valve is controlled by electrical current, which is run through a coil. When the coil is energized, a magnetic field is created, causing a plunger inside the coil to move.

Normally Closed Solenoid Valve: Normally closed solenoid valves may include a plunger that remains in a closed position when the system is running smoothly, like pressure relief valves. Normally closed solenoid valves may also include a coil that, when powered, will cause the plunger to open and allow liquid or gas to pass through the valve.

As used in the present disclosure, the term normally closed valve means the valve is normally closed until energized, once it receives power it opens, this is what the system uses to drain the water from the pipes.

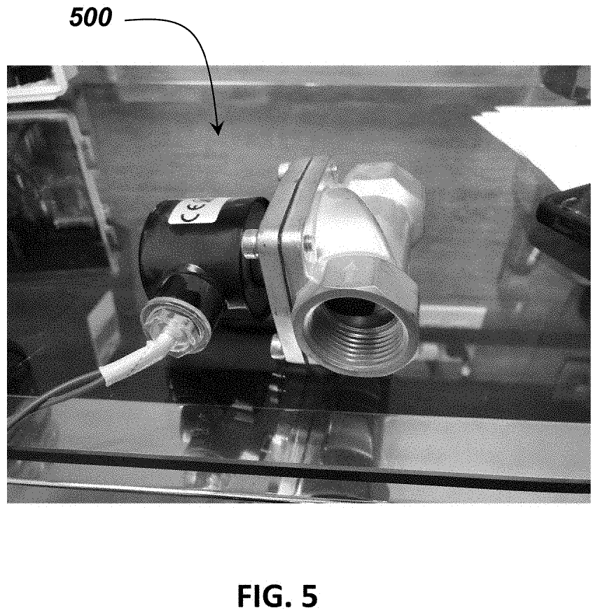

FIG. 5 illustrates an exemplary normally closed solenoid valve 500, according to some embodiments.

Normally open Solenoid Valve: is the opposite of the normally closed solenoid valve, it is always open when off, letting water pass though, once it receives power it closes, this is what the system uses to shut off the water.

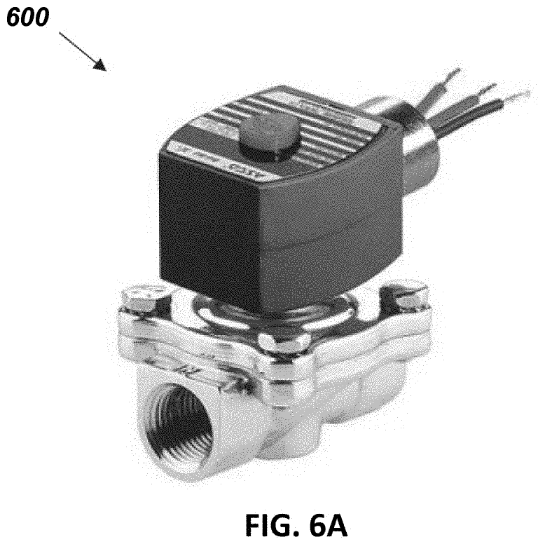

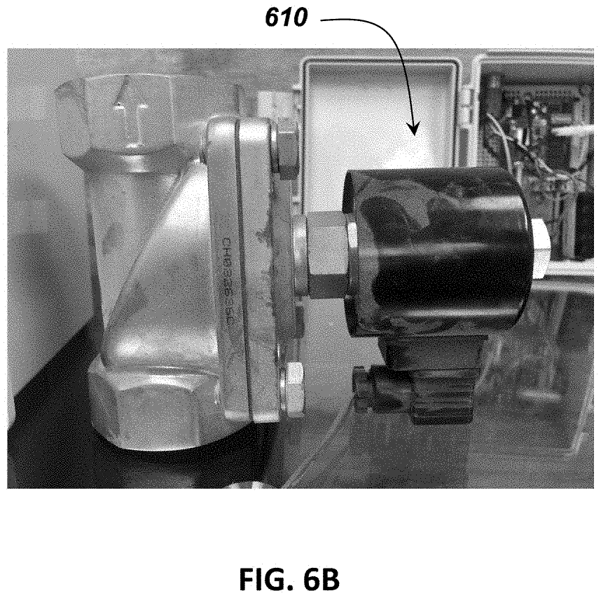

FIGS. 6A and 6B illustrate exemplary normally open solenoid valve 600 and 610, according to some embodiments.

AC-to-DC Power Supply: Such power supplies will employ a transformer to convert the input voltage to a higher or lower AC voltage. A rectifier is used to convert the transformer output voltage to a varying DC voltage, which in turn is passed through an electronic filter to convert it to an unregulated DC voltage.

Volt Meter: An instrument for measuring electric potential in volts.

Transmitter: A devise used to transmit signal from one place to the other is known as a transmitter. The signal may consist of information. It may use an antenna to transmit the signal in the air.

Receiver: A device which decodes the transmitted information from the received signal is known as a receiver. The receiver may also use an antenna to receive the signal from the air similar to the transmitter.

Siren: A siren is a loud noise-making device.

Wi-Fi Switch: A smart Wi-Fi switch can control power with a smartphone app or a button on the wall. The switch is wired to the electrical system to control the flow of an electrical power, and has a built-in Wi-Fi adapter to connect to the local network for communication with its smartphone app.

Wi-Fi Alarm: A Wi-Fi alarm is capable of connecting to a existing network wirelessly. Once triggered, it can send preset email and text message notifications making people aware it has been triggered.

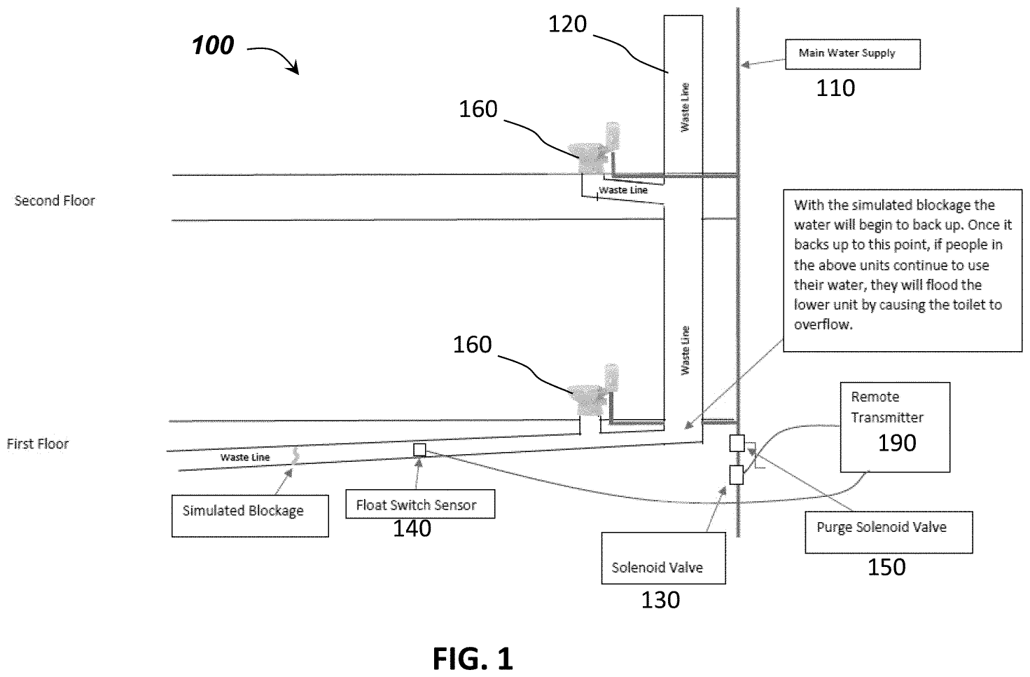

Embodiments of methods, devices, and systems for flood prevention system are described in FIGS. 1-8B. Generally, the present disclosure may include flood prevention system may include float switches that run parallel to the waste line and may be activated when the water backs up. This may trigger power gate valves that shut the water off to the units connected to the clogged waste line. When sewer lines back up they fill with water. The float switch sensor can detect when the pipes are full indicating there is an issue such as a blockage. It may then send a signal to a remote transmitter and that signal may then be picked up remotely by a receiver installed near the fresh main water supply line. In some embodiments, the signal from the receiver may set off a Wi-Fi alarm, for example to notify property owners, community managers and their emergency plumbers instantly, for example via text and/or email notifications. The receiver may also send a signal to a timer relay which can be set to a predetermined time, for example, one minute to two days. It will keep a normally open solenoid valve energized to stay closed for as long as desired which shuts off the water to the building giving the plumber time to resolve the issue before any flooding occurs. At the same time, a normally closed solenoid valve is opened to purge any residual water left in the water supply lines out of the pipes. This will ensure no further water can be used until the issue is resolved with the waste line.

In some embodiments, the system may also include a Wi-Fi smart switch which allows community managers, property owners and emergency plumbers to shut off the water via a smartphone app from anywhere in case an emergency plumbing call comes in requiring immediate shut off to prevent further damage. An example would be a broken pipe water supply or waste line.

FIG. 1 illustrates an exemplary flood prevention system 100 installed in a multistory building's sewer line. The building may be any residential or commercial property. The sewer line may include a waste line 120 and a water line 110. The waste line 120 may be connected to any plumbing fixture 160, for example, toilets, on each floor. The waste line 120 may also be connected to other areas of the building and to any plumbing fixture 160, including sinks, bathtubs, showers, etc. The water line 110 may similarly be connected to any plumbing fixture, for example toilets, and may connect to the plumbing fixture 160 above the position where the waste line 120 connects. Much like the waste line 120, the water line 110 may also be connected to other areas of the building to any plumbing fixture 160, including sinks, bathtubs, showers, etc.

In some embodiments, the flood prevention system 100 may include some exemplary components: a float switch sensor 140, a solenoid valve 130, and a purge solenoid valve 150. The float switch sensor 140 may be triggered using a triggering device when the water level in the sewer reaches a certain point, indicating that there is a blockage. The system may activate the solenoid valve 130 to turn off the water supply to the building. The purge solenoid valve 150 may open and purge any remaining water out of the pipes. As illustrated in FIG. 1, the float switch sensor 140 may be installed below the lowest plumbing fixture 160 within the waste line 120. Constituents in the waste line 120 may raise the float switch sensor 140 as the constituents rise up. The float switch sensor 140 may be connected, using any connection mechanisms, such as electrical connections, to any or all of the other components of the flood prevention system. When the float switch sensor 140 becomes buoyant, it may cause the solenoid valve 130, which may be attached to the water line 110, to shut off the water line.

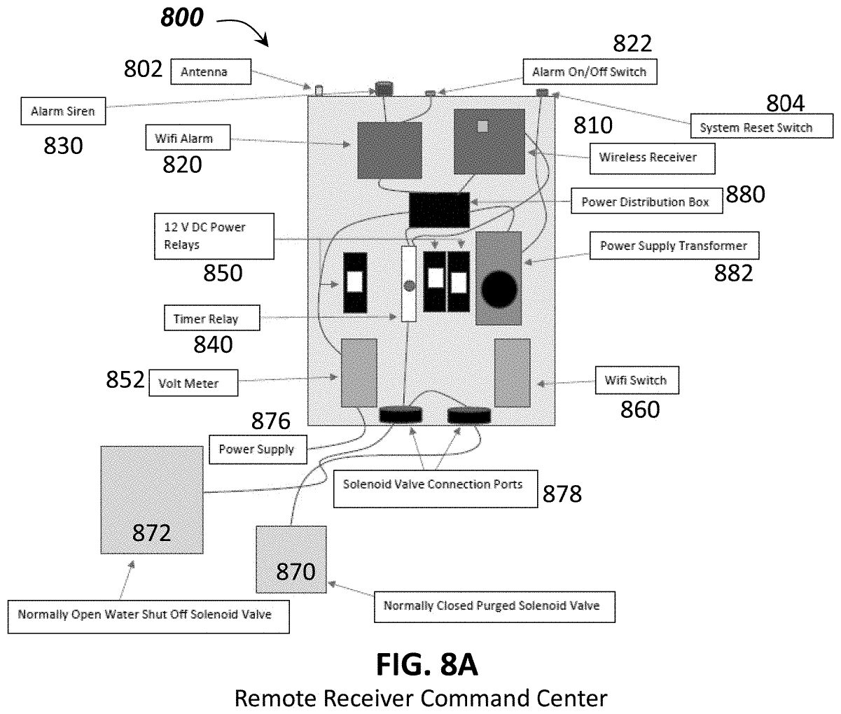

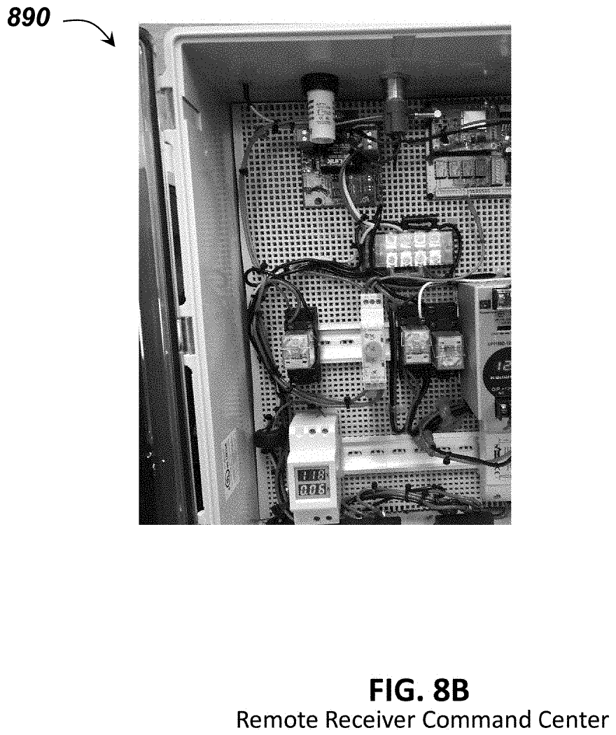

In some embodiments, the system may also include a remote transmitter 190, a purge solenoid valve 150 and a receiver command center (see FIGS. 8A and 8B). As will be described further below, the purge solenoid valve 150 may be controlled by the receiver command center when a signal is received by the remote command center, for example from the remote transmitter 190. The remote command center may then send power to a step-up relay and at the same time, or substantially at the same time engage both solenoid valves 130 and 150. The normally open solenoid valve 130 may turn off the water and the normally closed solenoid valve 150 may open to purge any residual water from the system.

In some embodiments, the remote transmitter 190 may be installed next to the float switch sensors 140. When a float switch sensor 140 becomes buoyant, it completes the circuit for the transmitter 190. The transmitter may send a signal to the receiver command center, which may then activate a Wi-Fi alarm and timer relay that will keep the water supply off for a preset time. The timer relay may energize the normally closed purge valve 150 and normally open solenoid valve 130, for example until the issue has been resolved or the system has been reset.

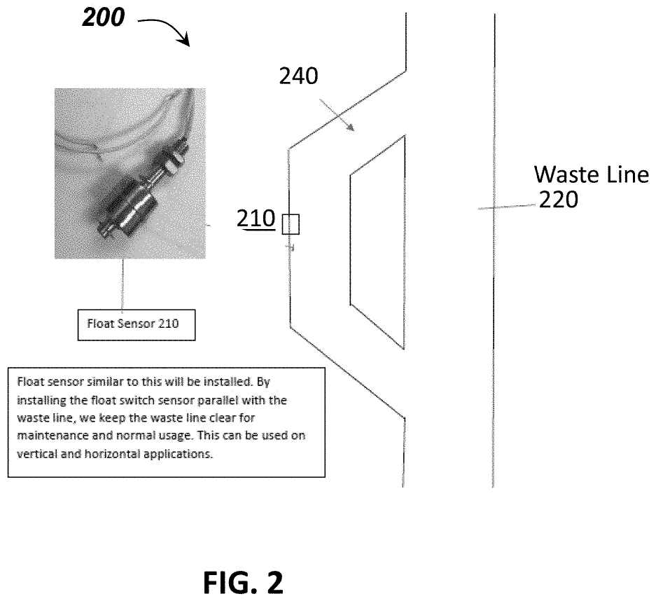

FIG. 2 illustrates an exemplary vertical waste line. As illustrated in FIG. 2, the flood prevention system 200 of the present disclosure may install a floating switch sensor 210 parallel with the waste line 220. It should be noted that such an installation may be used in vertical and horizontal pipelines. The floating switch sensor 210 may be installed substantially parallel to the waste line 220, either within the waste line 220 or in another pipeline 240 connected parallel to the waste line 220. In this configuration, the waste line 220 can be kept clear for maintenance and normal usage. The float switch is buoyant, it floats up and down, for example on that shaft 240. For a vertical pipe, the switch may be installed through the top and lowered down the pipe so a user (installer) may control where the water activates the switch. If the pipe is horizontal, the switch may be installed through the top so when water backs up it floats up and completes the circuit to turn on the system.

In some embodiments, the floating switch sensor may be separated from the waste line 220 using filter screens (not shown) that may filter out some of the waste from the waste line 220.

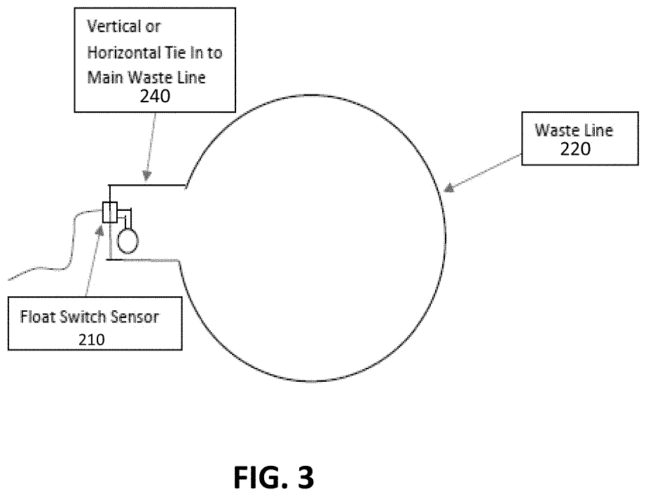

FIG. 3 illustrates an exemplary top-down view of the prevention system 200. A float switch sensor (depending on what type of switch is used.) can be floating in the middle of the pipe (as shown in FIG. 3 and FIG. 4) or mounted through the top.

In some embodiments, multiple sensors can be used, and the sensor location may be based on need and architecture.

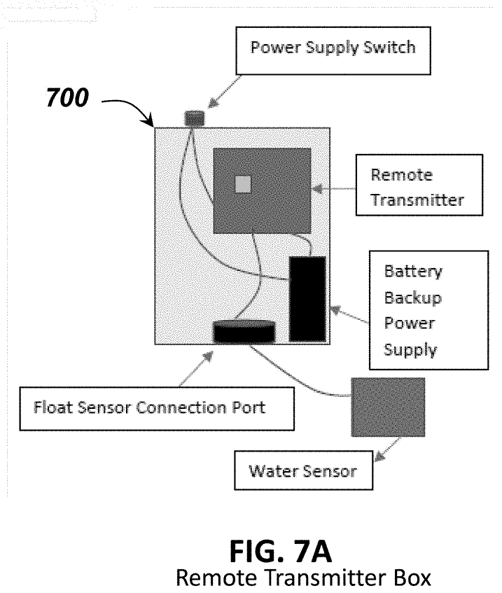

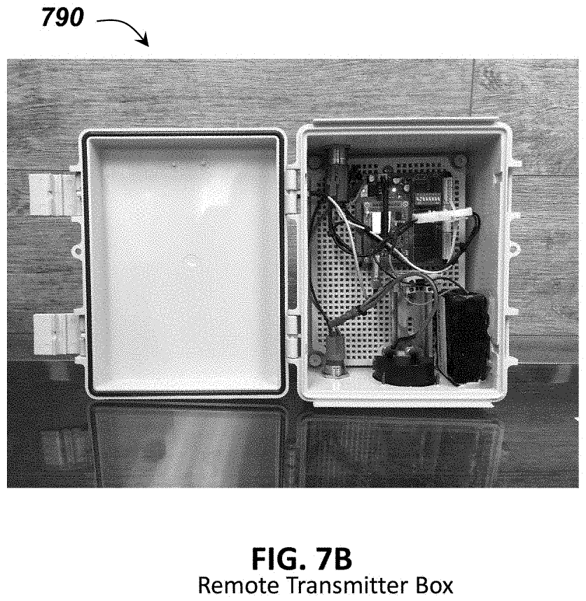

As shown in FIG. 1, a remote transmitter may be installed in the flood prevention system of the present disclosure. FIG. 7A illustrate an exemplary remote transmitter box 700, according to some embodiments. The remote transmitter box 700 may include a remote transmitter, a power supply switch, a battery back-up power supply, a power supply switch, a float sensor connection port to which a float sensor is connected.

FIG. 7B shows a photo of an exemplary remote transmitter box 790.

In some embodiments, the flood prevention system of the present disclosure may also include a remote receiver command center. FIG. 8A illustrate an exemplary remote receiver command center 800, according to some embodiments. The remote receiver command center 800 may include, among others, a power supply transformer 882, a power distribution box 880, 12V DC power relays 850, a volt meter 852 connected to a power supply 876, a timer relay 840, an antenna 802, an alarm siren 830, an alarm on/off switch 822, a Wi-Fi alarm 820, a wireless receiver 810, a system reset switch 804, a Wi-Fi switch 860, one or more solenoid valve connection ports 878 to which normally open water shutoff solenoid valve(s) and normally close purge solenoid valve(s) may be connected.

The remote receiver command center, or receiver command center 800 can be installed anywhere in or near the building, as long as the wires run to the solenoid valves. In practice, it is usually installed in safe places, for example, mechanical rooms. In some embodiments, the receiver command center 800 may receive the signal from the remote transmitter when the float switch is activated, as described above. The receiver command center will then send a signal to the Wi-Fi alarm 820 which may notify the issue, for example via text and/or email to predetermined personnel. The receiver command center 800 may also activate the optional alarm siren 830. In some embodiments, the receiver command center may then send power to a step-up relay 850. The relay uses a low voltage signal from the receiver to step up the power to 12 volt dc, which may be the required power to activate both normally closed and normally opened solenoid valves 870 and 872 (see also valves 150 and 130 in FIG. 1).

In some embodiments, the Wi-Fi switch 860, which is powered by the power supply 876, may allow users, for example via cell phone app, to remotely turn the water on and off in the building. This may be needed, for example, when a water supply line breaks. In some embodiments, the power supply 876 may provide power to the Wi-Fi switch 860 and the Wi-Fi switch 860 may send power to the solenoid valves in order to remotely turn them on and off.

FIG. 8B shows an exemplary photo of a remote receiver command center 890.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

1. A flood prevention system for a building which includes a water line, a sewer line, wherein the water line and the sewer line are connected to plumbing fixture, the flood prevention system comprising:
a remote receiver command center installed in the building;
one or more remote transmitter; and
one or more float switch sensor installed near each of the one or more remote transmitter; and wherein the one or more float sensor is installed within the sewer line.

2. The flood prevention system of claim 1, wherein the remote receiver command center comprises at least a Wi-Fi switch and one or more solenoid valve connection ports.

3. The flood prevention system of claim 2 further comprises one or more normally open water shutoff solenoid valve and one or more normally close purge solenoid valve connected to the one or more solenoid valve connection ports.

4. The flood prevention system of claim 3, wherein when a float switch sensor of the one or more float switch sensor becomes buoyant, it causes a normally open water shutoff solenoid valve of the one or more normally open water shutoff solenoid valve to close.

5. The flood prevention system of claim 4, wherein the normally open water shutoff solenoid valve closes for a preset time.

6. The flood prevention system of claim 4, wherein the remote transmitter sends a signal to an alarm.

7. The flood prevention system of claim 1, wherein the remote receiver command center receives a signal from the one or more remote transmitter.

8. The flood prevention system of claim 7, wherein the remote receiver command center receives the signal from the one or more remote transmitter when a float switch sensor of the one or more float switch sensor becomes buoyant.

9. The flood prevention system of claim 8, wherein the remote receiver command center causes a normally closed solenoid valve of the one or more normally close purge solenoid valve to open.

10. The flood prevention system of claim 1, wherein the one or more remote transmitter notifies a personnel of an issue.

11. A method for flood prevention in a building which includes a water line, a sewer line, wherein the water line and the sewer line are connected to plumbing fixture, one or more float switch sensor installed near each of the one or more remote transmitter, one or more normally open water shutoff solenoid valve, one or more normally close purge solenoid valve, and wherein the one or more float sensor is installed within the sewer line, the flood prevention method comprising:
causing, when a float switch sensor of the one or more float switch sensor becomes buoyant, a normally open water shutoff solenoid valve of the one or more normally open water shutoff solenoid valve to close;
receiving, by remote receiver command center, a signal from a remote transmitter of the one or more remote transmitter;
causing, by remote receiver command center, a normally closed solenoid valve of the one or more normally close purge solenoid valve to open.

12. The method of claim 11, wherein the normally open water shutoff solenoid valve closes for a preset time.

13. The method of claim 11, wherein the remote transmitter sends a signal to an alarm.

14. The method of claim 11, wherein the remote transmitter notifies a personnel of an issue.
